(19) United States
(12) Patent Application Publication
(10) Pub. No.: US 2010/0306501 A1
(43) Pub. Date: Dec. 2, 2010

(54) Hybrid Computer Systems

(75) Inventors: Teng-Chang Chang, Taipei City (TW); Yun-Kai Hsu, Donggang Township (TW); Yu-Zhi Chen, Liuying Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Institute for Information Industry, Taipei (TW)

(21) Appl. No.: 12/639,466

(22) Filed: Dec. 16, 2009

Related U.S. Application Data
(60) Provisional application No. 61/181,706, filed on May 28, 2009.

(51) Int. Cl. G06F 15/76; G06F 9/06; G06F 13/00

(52) U.S. Cl. 712/31; 710/100; 712/30; 712/E09.003

(57) ABSTRACT

A hybrid computer system is provided, including first and second computer devices. The first computer device is configured with the second computer device via a connection unit. Each of the first computer device and the second computer device is capable of operating independently when the first computer device and the second computer device are separated. The first computer device and the second computer device communicate with each other in a master-slave structure and combined with each other into a single system. The peripheral devices of the first and second computer devices are shared, wherein the first and second computer devices are master/slave systems or slave/master systems.

The present invention is a type of hybrid computer system, comprising a first computer device and a second computer device. The first computer device may be combined with or separated from the second computer device. The first computer device and the second computer device may be operated independently when separated. The first computer device and the second computer device use a master-slave structure to communicate with each other when they are combined together, thereby the first computer device and the second computer device are combined into a single system and share peripheral device connected to these two computer devices. Either of the first computer device and the second computer device can serve as a master or slave system.

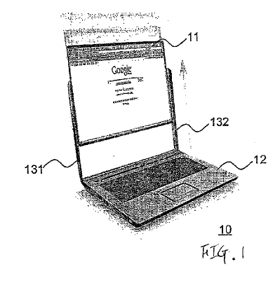

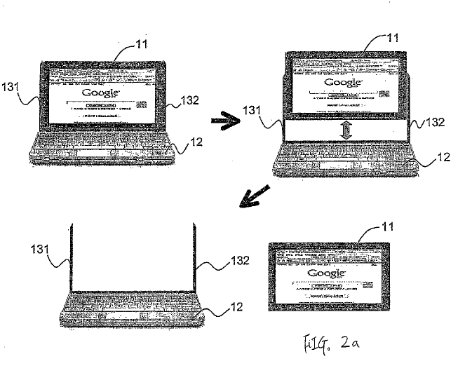

FIG. 1 is a schematic diagram illustrating an embodiment of a hybrid computer system 100 of the invention. The hybrid computer system 10 at least comprises a first computer device 11 and a second computer device 12. The second computer device 12 is equipped with a pair of slide bars 131 and 132 on two ends of the second computer device 12. The slide bars 131 and 132 extend outward from the corresponding ends of the second computer device 12. The first computer device 11 may be combined with or separated from the second computer device 12 via the guidance of the slide bars 131 and 132.

As to hardware design, each of the first computer device 11 and the second computer device 12 has a central processing unit (CPU), a memory storage unit and other peripheral devices or resources (for example, display panels, keyboards, wireless networking devices, Bluetooth devices, USB ports or other Input/Output ports). In addition, the first computer device 11 and the second computer device 12 can both be computer devices comprising display devices; or the first computer device 11 is a computer device comprising a display device, while the second computer device 12 is a computer device comprising a keyboard, disk driver devices, and related input/output devices. As to software design, both of the first computer device 11 and the second computer device 12 are installed with independent operating system (OS), i.e., a first operating system and a second operating system. The first operating system and the second operating system may communicate with each other and may also share files and resources. The first operating system and the second operating system may be operating systems of the same type or of different types.

One feature of the present invention is that, the first computer device 11 and the second computer device 12 form a single computer system when the first computer device 11 and the second computer device 12 are combined together. As shown in FIG. 1, the CPU, the storage unit and peripheral devices of the first computer device 110 and that of the second computer device 120 can be shared. Besides, the master-slave relationship between the first operating system and a second operating system installed in the first computer device 11 and the second computer device 12 can be determined by a user to meet requirements. For example, in a case where the second operating system is the master system, and the first operating system is configured to a sleep or shutdown mode when the first computer device 11 and the second computer device 12 are combined together, the second operating system takes over all the peripheral devices of the first computer device 11 and utilizes the display panel of the first computer device 11 to display information. In addition, virtual operating system can be used in the second operating system to implement the first operating system and associated applications of the first computer device 11, and then the operation results of the applications of the first operating system can be displayed on a single window by the second operating system, or can be displayed by switching between operation results of applications of the first operating system and the second operating system, or can be displayed by unity display presenting the operation results of the applications of the first operating system and the second operating system on the display screen.

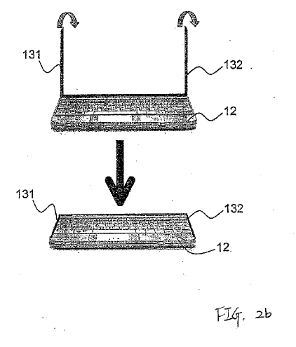

Another feature of the present invention is that, the first computer device 11 and the second computer device 12 can operate independently when they are separated. As shown in FIG. 2a, the first computer device 11 separates from the second computer device 12 via the guidance of the slide bars 131 and 132. At this time, as shown in FIG. 2b, the slide bars 131 and 132 may utilize the contact points to the second computer device 12 as the fulcrum points and then be folded up toward the second computer device 12. Accordingly, when the first computer device 11 and the second computer device 12 are separated from each other, the slide bars 131 and 132 are folded up toward the second computer device 12 and then are received on the second computer device 12. After the separation, the first computer device 11 can operated independently since it has its own CPU, storage unit, display device, and other required peripheral devices. Here, the display device of the first computer device 11 can be a touch panel or a multipoint touch panel, and the first computer device 11 can be used as a mobile internet device (MID). The second computer device 12 can be another independent mobile internet device, equipped with a touch panel or a multipoint touch panel. In addition, the second computer device 12 can be a computer dock equipped with a keyboard and other related input/output ports. In FIG. 2a, the second computer device 12 does not comprise a display device, but the second computer device 12 can connect to another independent display device via a proper display output port, such as VGA ports, DVI ports, AV and S-terminal ports, color difference terminals ports, HDMI terminal ports, or other display output ports, and display signals on the display device.

In addition, the central processing units suitable for the first computer device 11 and the second computer device 12 comprise, but are not limited to, x86, ARM, MIPS, or other central processing units. The operating system installed in the first computer device 11 and the second computer device 12 can be Microsoft™ Window-based OS, a Linux OS, an Android OS, a Mac OS, a Simbian OS, a Sun OS, a FreeBSD and other operating systems.

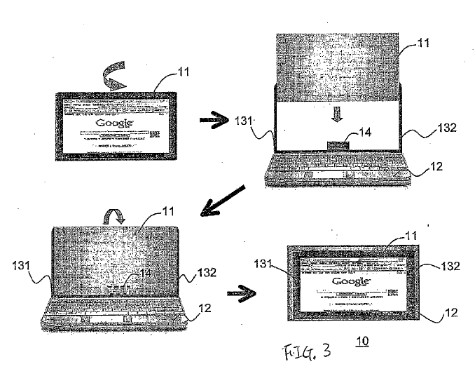

Referring to FIG. 3, the second computer device 12 may further have a bidirectional connector (dual connector) 14. The pins of the bidirectional connector may be designed such that the first computer device 11 can be operated normally when connecting to the second computer device 12 in either positive direction or reverse direction. Accordingly, as shown in FIG. 3, when two computer devices have been separated from each other, the first computer device 11 can first reverse 180 degrees and then connect to the second computer device 12 via the guidance of the slide bars 131 and 132. After the first computer device 11 has been stably connected to the second computer device 12, the first computer device 11 may further be folded toward the second computer device 12 such that the hybrid computer system 10 combined by the first computer device 11 and the second computer device 12 may become a tablet personal computer (PC). As the pins of the bidirectional connector are properly designed, the first computer device 11 can be operated normally on its own and the second computer device 12 can normally access peripheral devices, operating system, application programs and stored data of the first computer device 11.

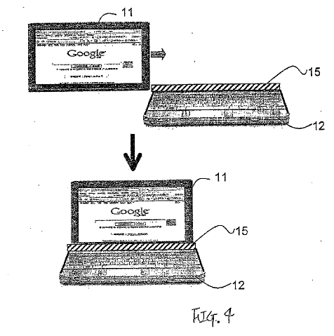

Furthermore, according to the present invention, connection between the first computer device 11 and the second computer device 12 is not limited to be directed by the pair of slide bars 131 and 132 illustrated in FIG. 1. As shown in FIG. 4, guidance trench 15 is equipped on one side edge of the second computer device 12, such that the first computer device 11 connects to the second computer device 12 by sliding into the guidance trench 15. In addition, magnetic connectors can be equipped on the second computer device 12 and/or the first computer device 11, thereby the first computer device 11 and the second computer device 12 can be connected by magnetic force generated by the magnetic connectors.

When the first computer device 11 is used as a mobile internet device or the first computer device 11 and the second computer device 12 are combined to form a tablet PC, it may be inconvenient for one-hand holding or manipulation due to dimensions of the design. Furthermore, when a user holds a computer with two hands, manipulation area for the user is limited. In addition, application programs are presented on anywhere of the display screen, the user cannot easily perform operation the computer (for example, selecting a certain item of an application program, or scrolling the display screen). According to the present invention, the first computer device 11 comprises double sidebars, wherein the double sidebars are mounted on the two opposite sides of the display screen of the first computer device 11. The double sidebars are suitable for manipulation with thumbs of two hands. A user can scroll the display by sliding thumbs, can select item by clicking thumbs, and can select hierarchical menu by left and right thumbs. In addition, icons displayed on the double sidebars can be changed corresponding to different application programs or operating systems.

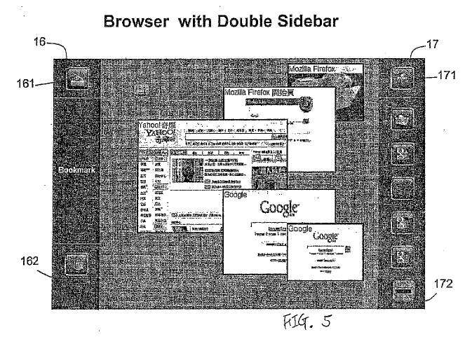

Referring to FIG. 5, the double sidebars of the present invention are implemented in a browser application program. A ‘leave’ icon 161 is set on the top of left sidebar 16. A user can click this icon with his/her thumb to close an opening browser window or to return to a preceding browser page. An arrangement icon 162 is set on the bottom of the left sidebar 16 for arranging opening browser windows or web pages by a scroll or cover flow. Thus a user can see all the opening browser windows or web pages at a glance, and can select among them easily. Icons representing bookmarks can be set in the middle of the left sidebar 16. Thus a user can open a browser window and link to the corresponding web pages by a touch operation. An ‘upward scroll’ icon 171 and a ‘downward scroll’ icon 172 are set on the top and bottom of right sidebar 17, respectively. A user can scroll a web page by touching the icon with his/her thumb; a user can also press the arrangement icon 162 of left sidebar 16 to arrange opening browser windows by a scroll or cover flow, and then use the ‘upward scroll’ icon 171 and ‘downward scroll’ icon 172 to switch the web page window. Icons representing browsers can be set in the middle of the right sidebar 17. A user can press these icons to open or switch to the corresponding browsers.

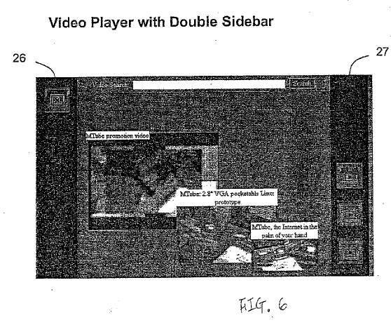

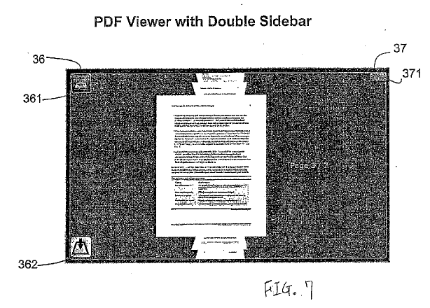

FIG. 6 illustrates a case where the double sidebars of the present invention are implemented in a video playback application program. Referring to FIG. 6, a ‘leave’ icon 261 is set on the top of left sidebar 26. A user can click this icon with his/her thumb to close an opening or playing video window. Icons are set on the right sidebar 27 corresponding to opening or playing video windows. A user can press these icons to open a video window corresponding to the icon or switch to the corresponding video windows.

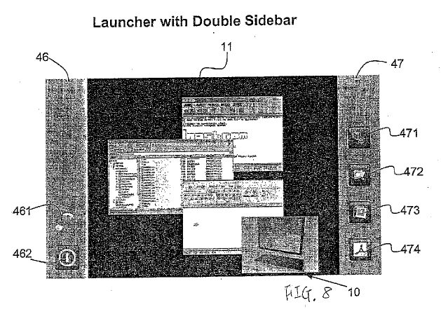

FIG. 7 illustrates a case where the double sidebars of the present invention are implemented in a document editor or document viewer. An ‘open’ icon 361 is set on the top of left sidebar 36. A user can click this icon with his/her thumb to open a document. A ‘store’ icon 362 is set on the bottom of left sidebar 36. A user can click this icon with his/her thumb to store an editing or viewing document. A ‘leave’ icon is set on the top of right sidebar 37. A user can close an opening document editor or document viewer window by a touch operation.

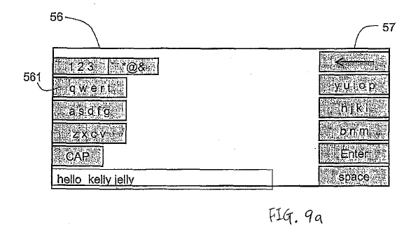

FIG. 8 illustrates a case where the double sidebars of the present invention are implemented in an operating system installed in a first computer 10. A ‘sleep’ icon 461 and a ‘power off’ icon are set on left sidebar 46. A user can click these icons with his/her thumb(s) to cause the operating system of the first computer 11 into a sleep mode or to close the operating system. Icons 471, 472, and 473 representing application programs are set on the bottom of right sidebar 46. A user can touch the icons 471, 472, 473, and 474 to open or switch to a window for the corresponding application program.

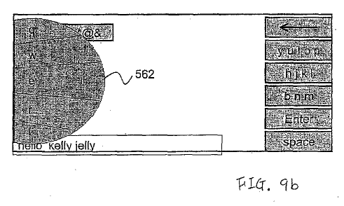

FIGS. 9a and 9b illustrate a case where the double sidebars of the present invention are implemented in English character input mode. The left sidebar 56 and right sidebar 57 are equipped with icons representing English characters, numbers, symbols, and other function keys (such as Esc, delete, space, caps lock). These English characters and numbers are presented in groups on the double sidebars, rather then presented by respective icons. For example, as shown in FIG. 9a, the English characters ‘QWERT’ are presented by the same icon 561. Referring to FIG. 9b, when the character ‘E’ is to be input, the icon 561 should be touched, and a fan-shaped pop-up selection area 561 is then displayed on left sidebar 56, areas representing characters ‘Q’, ‘W’, ‘E’, ‘R’, and ‘T’ are displayed on the fan-shaped selection area 561. The input operation of character ‘E’ can then be completed by selecting the ‘E’ displayed on the fan-shaped selection area 561. Furthermore, these English characters are not grouped by alphabetic order. Based on statistics and simulation of general input order of human hands on a standard 101-key keyboard, English characters arranged in adjacency on the standard keyboard are grouped together and represented by the same icon. For example, ‘Q, W, E, R, T’ are presented by icon 561, and ‘Y, U, I, O, P’ are presented by icon 562, and the icons 561 and 562 are arranged on the top of left sidebar 56 and right sidebar 57. Accordingly, it is easy for a user to get familiar with the text input mode provided by the double sidebars of the present invention, and there is no need for the user to learn another new input method.

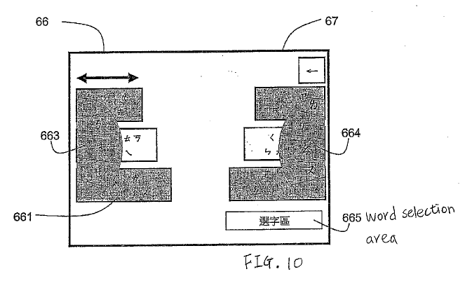

FIG. 10 illustrates a case where the double sidebars of the present invention are implemented in Chinese character input mode. Vowels and consonants in mandarin phonetic symbols can be used for Chinese character input, and a suitable word can be selected from homonyms. Accordingly, a word selection area 665 is set on the double sidebars. The left sidebar 66 and right sidebar 67 are equipped with icons representing mandarin phonetic symbols and other function keys (such as Esc key). These mandarin phonetic symbols are presented in groups on the double sidebars, rather then presented by respective icons. For example, as shown in FIG. 10, the mandarin phonetic symbols [symbol] are presented by the same icon 661. When the character [symbol] is to be input, the icon 661 should be touched, and a fan-shaped pop-up selection area 663 is then displayed on left sidebar 66, areas representing characters ‘ [symbol] , and [symbol] are displayed on the fan-shaped selection area 663. The input operation of character [symbol] can then be completed by selecting the [symbol] displayed on the fan-shaped selection area 663. At this time, the use can touch a next mandarin phonetic symbol on the right sidebar 67, and a fan-shaped pop-up selection area 664 is then displayed on right sidebar 67. A user can then select a mandarin phonetic symbol is by clicking one of the mandarin phonetic symbols displayed on fan-shaped selection area 664 by his/her right thumb. When the mandarin phonetic symbols are input, homonyms corresponding to the input phonetic symbols are displayed in the word selection area. The user then select a Chinese word by clicking the word by his/her thumb. Furthermore, these mandarin phonetic symbols are not grouped by alphabetic order. The mandarin phonetic symbols are arranged based on statistics and simulation of a general input method. Accordingly, it is easy for a user to get familiar with the text input mode provided by the double sidebars of the present invention, and there is no need for the user to learn another new input method. The described arrangement can be implemented in a text input system for selecting suitable ideograms from corresponding phonetic symbols, such as input system for Japanese or Korean.

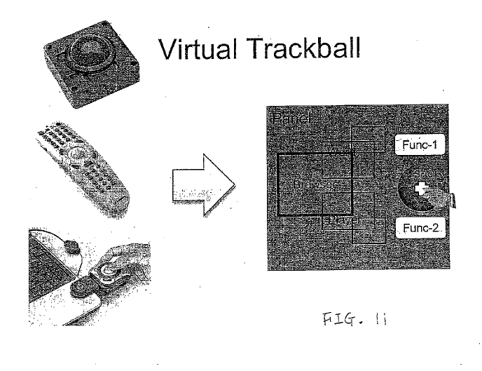

In addition, the scroll function of the double sidebar of the present invention can be implemented by an external virtual trackball, as shown in FIG. 11.

What is claimed is:

1. A hybrid computer system, comprising:
a first computer device, having at least one first processing unit, one first storage unit and one first OS; and
a second computer device, having at least one second processing unit, one second storage unit and one second OS,
wherein the second computer device comprises a connection unit and is combined with the first computer device via the connection unit such that the first and second computer devices are combined into a single system and the first processing unit, the first storage unit and the first OS of the first computer device and the second processing unit, the second storage unit and the second OS of the second computer device are shared with the single system, wherein the first computer device independently utilizes the first processing unit, the first storage unit and the first OS while the second computer device independently utilizes the second processing unit, the second storage unit and the second OS when the first computer device is separated from the second computer device.

2. The hybrid computer system of claim 1, wherein the first computer device further comprises a first resource and the second computer device further comprises a second resource, and the first and second resources are shared with the single system when the first and second computer devices are combined into the single system.

3. The hybrid computer system of claim 1, wherein the first computer device is combined with the second computer device by a wedge or a bearing.

4. The hybrid computer system of claim 3, wherein the connection unit of the second computer device is a slide bar, and the first computer device is combined with or separated from the second computer device via the guidance of the slide bar.

5. The hybrid computer system of claim 3, wherein the connection unit of the second computer device is a connector, and the first computer device is combined with or separated from the second computer device via the connector.

6. The hybrid computer system of claim 1, wherein the first computer device communicates with the second computer device in a master-slave structure and the first computer device or the second computer device is configured to be a master system or a slave system.

7. The hybrid computer system of claim 6, further comprising a display device for displaying the OS environment corresponding to the master system.

8. The hybrid computer system of claim 7, further comprising a switching unit for switching the first computer device or the second computer device to be the master system and displaying the OS of the master system in the display unit.

9. The hybrid computer system of claim 6, wherein the OS of the master system further determines to configure the first computer device or the second computer device as the master system according to actual application requirements.

10. The hybrid computer system of claim 9, wherein the processing unit of the slave system is configured to the sleep mode when the slave system is not operating.

11. The hybrid computer system of claim 1, wherein a type of the operation system of the first OS is different from that of the second OS.

12. The hybrid computer system of claim 1, wherein a type of the first processing unit is different from that of the second processing unit.

13. The hybrid computer system of claim 1, wherein the first and second computer devices are portable electronic devices or mobile devices.

14. The hybrid computer system of claim 1, wherein the hybrid computer system is used as a mobile internet device, a laptop computer system or a tablet personal computer.

15. A hybrid computer system, comprising:
a first computer device, having at least one first processing unit, one first storage unit, one first OS and one touch-sensitive screen; and
a second computer device, having at least one second processing unit, one second storage unit, one second OS and one input device, wherein the second computer device comprises a connection unit and is combined with the first computer device via the connection unit,
wherein the first and second computer devices are combined into a single system and the single system utilizes the input device of the second computer device for inputting data and utilizes the touch-sensitive screen of the first computer device for outputting data and the first processing unit, the first storage unit and the first OS of the first computer device and the second processing unit, the second storage unit and the second OS of the second computer device are shared with the single system, wherein the first computer device utilizes the first processing unit, the first storage unit and the first OS while the second computer device utilizes the second processing unit, the second storage unit and the second OS independently when the first computer device is separated from the second computer device.

16. The hybrid computer system of claim 15, wherein the second computer device further comprises a display output interface and the second computer device further connects to a display unit and configures the display unit as the output device via the display output interface when the first computer device is separated from the second computer device.

17. The hybrid computer system of claim 15, wherein the first computer device is combined with the second computer device by a wedge or a bearing.

18. The hybrid computer system of claim 17, wherein the connection unit of the second computer device is a slide bar, and the first computer device is combined with or separated from the second computer device via the guidance of the slide bar.

19. The hybrid computer system of claim 15, wherein the first computer device communicates with the second computer device in a master-slave structure and the first computer device or the second computer device is configured to be a master system or a slave system.

20. The hybrid computer system of claim 19, further comprising a switching unit for switching the first computer device or the second computer device to be the master system and displaying the OS of the master system in the display unit.

21. The hybrid computer system of claim 20, wherein the OS of the master system further determines to configure the first computer device or the second computer device as the master system according to actual application requirements.

22. The hybrid computer system of claim 21, wherein the processing unit of the slave system is configured to the sleep mode when the slave system is not operating.

23. The hybrid computer system of claim 15, wherein the first and second computer devices are portable electronic devices or mobile devices.

24. The hybrid computer system of claim 15, wherein the hybrid computer system is used as a mobile internet device, a laptop computer system or a tablet personal computer.
